(19) United States
(12) Patent Application Publication
(10) Pub. No.: US 2018/0004767 A1
(43) Pub. Date: Jan. 4, 2018

(54) REST APIs for Data Services

(71) Applicant: Microsoft Technology Licensing, LLC., Redmond, WA (US)

(72) Inventors: Charles Lamanna, Bellevue, WA (US); Sameer Chabungbam, Redmond, WA (US); Vinay Singh, Redmond, WA (US); Henrik Frystyk Nielsen, Hunts Point, WA (US); Steven Paul Goss, Issaquah, WA (US); Jeffrey Scott Hollan, Snoqualmie, WA (US); Stephen Siciliano, Bellevue, WA (US)

(73) Assignee: Microsoft Technology Licensing, LLC., Redmond, WA (US)

(21) Appl. No.: 15/199,818

(22) Filed: Jun. 30, 2016

(51) Int. Cl. G06F 17/30; H04L 29/08

(52) U.S. Cl. CPC G06F 17/30115; G06F 17/30345; G06F 17/30318; H04L 67/1097

(57) ABSTRACT

Embodiments are directed to connectors that use a common contract to expose data sources to applications. The common contract provides access to a plurality of different dataset types without requiring the applications to know the specific dataset type used by the data sources.

### BACKGROUND

Applications frequently need to take advantage of remote services, such as accessing third-party data sources and other services. Developers need to have detailed knowledge of the interfaces to the remote services so that the application can interact with the third-party service. This typically requires the developer to understand the Application Program Interface (API) used by the remote service or to create integration software to support access to the remote service. The developer may need to design some proprietary middleware or create chains of conditional statements to provide such remote service interaction. Such solutions are specific to a particular application and a particular remote service. The middleware or bundle of conditional statement typically cannot be used by the application to access other services and cannot be shared with other applications to access the specific service.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments are directed to connectors that use a common contract to expose data sources to applications. The common contract provides access to a plurality of different dataset types without requiring the applications to know the specific dataset type used by the data sources.

The connector exposes an application program interface (API) for managing datasets according to the common contract. The common contract provides a standardized interface to perform Create, Read, Update, Delete (CRUD) operations on the data sources using APIs. The data source may comprise a tabular data resource hierarchy, wherein the application calls the APIs to manage tables and items in the data set using the common contract. Alternatively, the data source may comprise a blob data resource hierarchy, wherein the application calls the APIs to manage folders and files.

The connector may expose APIs for triggering actions when a dataset event is detected.

The connector may be a composite connector that exposes APIs for managing data resources using both a tabular data hierarchy and a blob data hierarchy according to the common contract.

A plurality of connectors may be hosted on a distributed computer network hosting, wherein each of the connectors is associated with a different data source and exposes APIs for managing data on each data source according to the common contract.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a system employing an API hub between client applications and other data sources and services.

FIG. 2 is a block diagram showing connectors used in a cloud-services network.

FIG. 3 illustrates the resource hierarchy for tabular data that is organized as tables and items.

FIG. 4 illustrates the resource hierarchy for blob data that is organized as a series of folders with files or containers with blobs.

FIG. 5 is a high level block diagram of an example datacenter that provides cloud computing services or distributed computing services using connectors.

### DETAILED DESCRIPTION

The present disclosure relates generally to connector APIs for performing CRUD (Create, Read, Update, Delete) operations on data sources. The connectors may be used in a hosted environment, such as in a distributed computing system or with public or private cloud services. The connectors may also be used in an enterprise environment that allows a user to connect to their own networks and data sources.

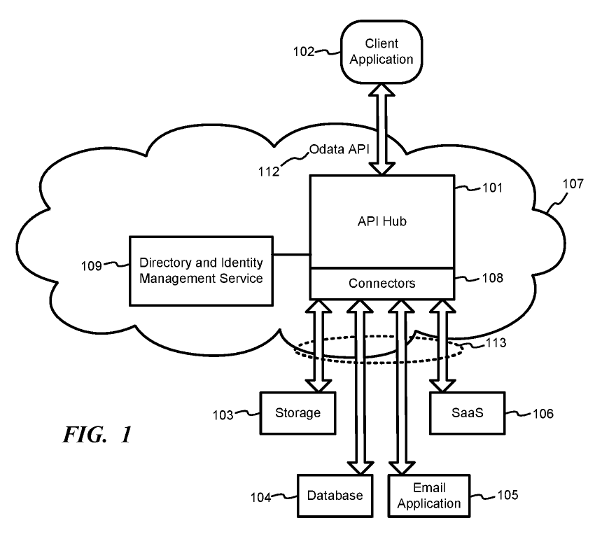

FIG. 1 is a block diagram of a system employing connectors using an API hub 101 between client application 102 and other data sources and services 103-106. Client application 102 may be running on any platform, such as an application running on a smartphone in a browser, as a native file, or an OS application. The client application may be created using the PowerApps service from Microsoft Corporation, for example. The other data sources and services may include, for example, a storage provider 103, database provider 104, email application 105, or other services/SaaS 106. API hub 101 is running in a cloud service 107. Connectors 108 provide a common way for client application 102 to access the APIs for data sources and other services 103-106.

Directory and identify management service 109 authenticates user credentials for users of client application 102 on cloud service 107. During runtime, API hub 101 transforms the user credentials for the user of client application 102 to the user credentials required by a specific connector 108. API hub 101 stores the user credentials associated with the client application 102 and applies any quota, rate limits, or usage parameters (e.g., number of API calls per minute, number of API calls per day, etc.) as appropriate for the user.

During runtime, client application 102 may need to access storage 103 and database 104. Each of the remote data sources and services 103-106 have their own set of credentials that are required for access.

In one embodiment, client application 102 uses a common data protocol, such as OData (Open Data Protocol) APIs, 112 to make calls against remote data sources and services 103-106 to API hub 101. Then API hub 101 then translates or modifies the API call 112 from client service 102 to the proprietary API 113 used by the called remote data source or service. API hub 101 also applies quota, rate limits, or usage parameters that apply to the user context or the remote data sources services, such as limiting the number of calls per time period and/or per user. API hub 101 then forwards the API call to the appropriate remote data source or service. The response from the called remote data source or service is then relayed back to client application 102 through API hub 101.

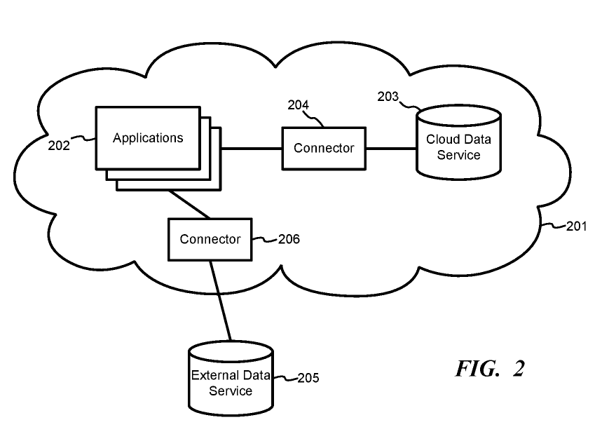

FIG. 2 is a block diagram showing connectors used in a cloud-services network 201. Cloud-based applications 202, such as LogicApps from Microsoft Corporation, may access data services using connectors. Could-based data service 203 may be accessed using connector 204, for example. External data service 205 may be accessed by applications 202 using connector 206.

Connectors 108 (FIGS. 1) and 204, 206 (FIG. 2) enable different scenarios. The client applications 102 may be, for example, web and mobile applications that are created using templates and a drag-and-drop editor. Connectors 108 support CRUD operations in APIs. Connectors 108 have a standard contract that allows a user with limited coding experience to create client application 102 that can access data sources and perform CRUD operations on data tables. Alternatively, application 202 may be workflow logic running in cloud service 201 as a backend service that automates business process execution. Connectors 204, 206 allow for certain events to trigger other actions.

The connectors disclosed herein have a standard contract for how CRUD operations are consumed by users that provides a generic extensibility model. The contract is based on a common data model, such as open data protocol (OData). While OData is an Extensible Markup Language (XML) standard, extensions have been added so that the connectors support JavaScript Object Notation (JSON) data format.

The connectors provide REST (REpresentational State Transfer) APIs for data services. A connection profile contains the information required to route at request to the associated connector. The connection profile also has any necessary information (e.g., connection string, credentials, etc.) that the connector would use to connect to the external service. The external services may include, for example, storage services, database services, messaging services (e.g., email, text, SMS, etc.), Software as a Service (SaaS) platforms, collaboration and document management platforms, customer relationship management (CRM) services, and the like. The resource hierarchy for the data services contracts are discussed below. At a high level, there are two types of connectors: tabular data and blob data.

Tabular data is organized as columns and rows, such as spreadsheets. A dataset represents a collection of tables, such as multiple sheets in a spreadsheet document wherein each sheet has its own table. For the connectors, a single data source (e.g., a single database) has series of different tables. Accordingly, the tables relate to the same data source, but each table has a different set of columns and rows.

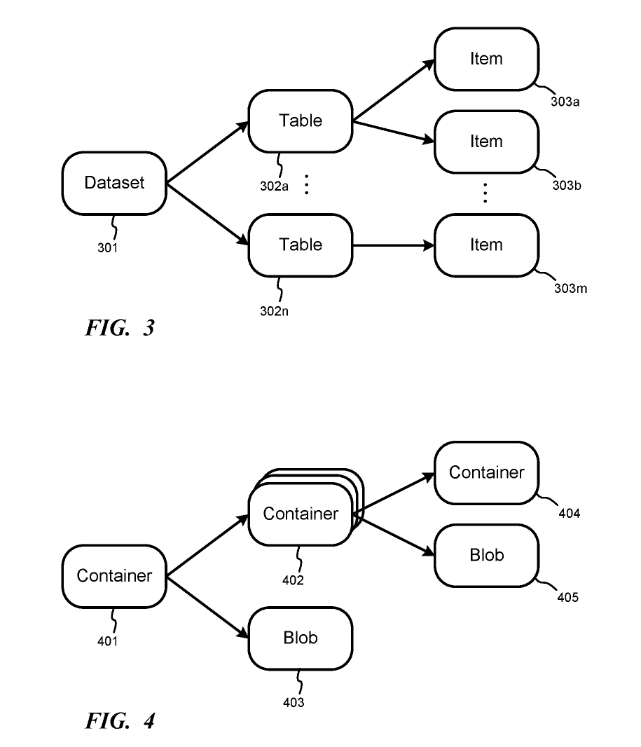

FIG. 3 illustrates the resource hierarchy for tabular data. A dataset 301 exposes a collection of tables 302a-n. Each table 302 has rows and columns that contain data. An item 303a-m represents a row in one of the tables 302.

Given the above contracts for the tabular data, a standardized user interface can be developed for navigating and discovering this hierarchy data in the context any type of connector. A specific connector is provided to each type of service. For example, a connector is provided to SharePoint, SQL, etc. The following is a list of example datasets and tables for different types of connectors. A SQL connector is used to access a database type dataset having a series of tables, an Excel connector is used to access an Excel file dataset having a series of sheets, etc.

| Connector | Dataset | Table |
|---|---|---|
| SharePoint | Site | SharePoint List |
| SQL | Database | Table |
| Google Sheet | Spreadsheet | Worksheet |
| Excel | Excel file | Sheet |

The contract works across any service, and each service has its own connector. A generic contract, such as a tabular data contract, exists for different underlying data services. For example, both SharePoint and SQL have different implementations of datasets, tables and rows, but the underlying contract used by both is identical (i.e., dataset—tables—items as illustrated in FIG. 3). Each connector is a particular implementation of a service that uses the contract.

In one embodiment, the connectors always expose OData to users, but the various services to which the connectors connect may not expose data in the same form. Although the different data services' APIs may be different from OData, but the connectors make provide a uniform interface to client applications by using OData. This allows client applications to make the same API call to perform the same action regardless of the data service that is accessed.

The following services expose management APIs for tabular data contracts. For each REST API illustrated below, the Request URI called by the client application is shown along with any argument or other parameters required. The HTTP status code received in response along with the response body are also shown. It will be understood that the specific content of the requests and responses illustrated herein represent example embodiments and are not intended to limit the scope of the invention. The APIs allow a client application to move through the tabular data hierarchy by identifying datasets, then identifying tables in the datasets, and then identifying items in the tables. The client application may then perform operations on the data, such as adding, deleting, and patching items, or gathering metadata about the tables.

Dataset Service—this service exposes a management API for datasets.

List Datasets—the following defines a REST API for discovering datasets in a particular service. The same call can be made against any tabular data service regardless of whether the service datasets are sites, databases, spreadsheets, Excel file, etc. The response will provide a list of the datasets on the service that has been called by the List Datasets operation.

| | HTTP | |
|---|---|---|
| Request | Method | Request URI |
| | GET | /datasets?$top=50 |
| Request | $top query parameter is used to specify desired page size | |
| Parameters | | |
| | Status Code | |
| Response | HTTP Status | Scenario |
| | 200 | Operation completed successfully |
| | 401 | Unauthorized request |

| | |
|---|---|
| Response | { |

| | |
|---|---|
| Body | “value”: [ |

{

“name” :

“https://microsoft.sharepoint.com/teams/appPlatform”

},
...,

],
“odata.nextLink” :

“{originalRequestUrl}?$skip={opaqueString}”
}
The nextLink field is expected to point to the URL the
client should use to fetch the next page (per server
side paging

Table Service—this service exposes management API for table.

| | HTTP | |
|---|---|---|
| Request | Method | Request URI |
| | GET | /$metadata.json/datasets/{datasetName}/ |
| | | tables/{tableName}?api-version= 2015-09- |
| | | 01 |
| Request | | |
| Parameters | Argument | Description |
| | datasetName | Name of the dataset |
| | tableName | Name of the table |
| | Status Code | |
| Response | HTTP Status | Scenario |
| | 200 | Operation completed successfully |
| | 400 | Invalid request parameters/body |
| | 401 | Unauthorized request |
| | 404 | Non-existent dataset/table |

| | |
|---|---|
| Response Body | { |

“name” : “Sheet1”,
“title” : “Sales data”
“x-ms-permission” : “read-only” | “read-write”,
“capabilities” : {

“paging” : “ForwardOnly” | “ForwardAndBackward”

“None”,

| } | |
|---|---|
| schema : { | ---- JSON schema of the table |

“type” : “array”,
“items” : {

“type” : “object”,
“required” : [

“column1”,
...

],
“properties” : {

“column1” : {

| | |
|---|---|
| “title”: “BugId”, | --- Used as display |

name. Default to column name if not present

| “description” : “BugId”, | |
|---|---|
| “type” : “integer”, | --- |

Required

“format” : “int32”,

| | |
|---|---|
| “default” : null, | ---- |

null | Object

| | |
|---|---|
| “x-ms-keyType” : “primary”, | ---- “primary” |

| “none”. Required for key columns

| | |
|---|---|
| “x-ms-keyOrder” : 1, | ---- |

Required for key columns

| | |
|---|---|
| “x-ms-visibility” : “”, | ---- |

Empty | “Advanced” | “Internal”,

| | |
|---|---|
| “x-ms-permission” : “read-only”, | ---- |

“read-only” | “read-write”

“x-ms-sort” : “asc”, “desc”, “asc,desc”, “none”

},
“column2” : {

| “title” : “BugTitle”, | |
|---|---|
| “description” : “BugTitle”, | |
| “type” : “string”, | --- |

Required

| | |
|---|---|
| “maxLength” : ”256”, | --- |

applicable for string data-type

“format” : “string”,

| | |
|---|---|
| “default” : null, | ---- |

null | Object

| | |
|---|---|
| “x-ms-visibility” : “”, | ---- |

Empty | “Advanced” | “Internal”,

| | |
|---|---|
| “x-ms-permission” : “read-write”, | ---- |

“read-only” | “read-write”

“x-ms-sort” : “asc,desc”

},
...

}

}

},

}

List Tables—the following defines a REST API for enumeration of tables in a dataset. Once the datasets on a service are known, such as by using the List Datasets operation above, then the tables within each dataset can be identifed.

| Request | HTTP Method | Request URI |
|---|---|---|
| | GET | /datasets/(‘{datasetName}’)/tables?api- |
| | | version=2015-09-01 |
| Request | | |
| Parameters | Argument | Description |
| | datasetName | Name of the dataset |
| | Status Code | |
| Response | HTTP Status | Scenario |
| | 200 | Operation completed successfully |
| | 400 | Invalid request parameters/body |
| | 401 | Unauthorized request |
| | 404 | Non-existent dataset |

| | |
|---|---|
| Response | { |

| | |
|---|---|
| Body | “value” : [ |

{

“name” : “Sheet1”,

},
...

],
“odata.nextLink” :
“{originalRequestUrl}?$skip={opaqueString}”

}

Table Metadata Service—this service exposes table metadata APIs. Once the tables have been identified within the datasets, then metadata can be obtained for each table.

Get Table Metadata—this API provides following metadata about a table:
1) Name
2) Capabilities—e.g., whether the table supports filtering, sorting, etc.
3) Schema—JSON based schema containing properties for each column present in the table.

| Request | HTTP Method | Request URI |
|---|---|---|
| | GET | /$metadata.json/datasets/{datasetName}/ |
| | | tables/{tableName}?api-version=2015-09-01 |
| Request | | |
| Parameters | Argument | Description |
| | datasetName | Name of the dataset |
| | tableName | Name of the table |

Request Body

| | Status Code | |
|---|---|---|
| Response | HTTP Status | Scenario |
| | 200 | Operation completed successfully |
| | 400 | Invalid request parameters/body |
| | 401 | Unauthorized request |
| | 404 | Non-existent dataset/table |

| | |
|---|---|
| Response | { |

| | |
|---|---|
| Body | “name” : “Sheet1”, |
| | “title” : “Sales data” |
| | “x-ms-permission” : “read-only” \| “read-write”, |
| | “capabilities” : { |

“paging” : “ForwardOnly” | “ForwardAndBackward” |

“None”,

| } | |
|---|---|
| schema: { | ---- JSON schema of the table |

“type” : “array”,
“items” : {

“type” : “object”,
“required” : [

“column1”,
...

],
“properties” : {

“column1” : {

| | |
|---|---|
| “title”: “BugId”, | --- Used as display |

name. Default to column name if not present

| “description” : “BugId”, | |
|---|---|
| “type” : “integer”, | -- |

- Required

“format” : “int32”,

| | |
|---|---|
| “default” : null, | ---- |

null | Object

| | |
|---|---|
| “x-ms-keyType” : “primary”, | ---- |

“primary” | “none”. Required for key columns

| | |
|---|---|
| “x-ms-keyOrder” : 1, | ---- |

Required for key columns

| | |
|---|---|
| “x-ms-visibility” : “”, | ---- |

Empty | “Advanced” | “Internal”,

| | |
|---|---|
| “x-ms-permission” : “read-only”, | ---- |

“read-only” | “read-write”

“x-ms-sort” : “asc”, “desc”, “asc,desc”, “none”

},
“column2” : {

| “title” : “BugTitle”, | |
|---|---|
| “description” : “BugTitle”, | |
| “type” : “string”, | --- |

Required

| | |
|---|---|
| “maxLength” : ”256”, | --- |

applicable for string data-type

“format” : “string”,

| | |
|---|---|
| “default” : null, | ---- |

null | Object

| | |
|---|---|
| “x-ms-visibility” : “”, | ---- |

Empty | “Advanced” | “Internal”,

| | |
|---|---|
| “x-ms-perrnission” : “read-write”, | ---- |

“read-only” | “read-write”

“x-ms-sort” : “asc,desc”

},
...

}

}

},

}

Table Data Service—this service exposes runtime APIs for CRUD operations on a table.

Create A New Item—the following defines a REST API for creation of a new item in a table.

| Request | HTTP Method | Request URI |
|---|---|---|
| | POST | /datasets/{datasetName}/tables/ |
| | | {tableName}/ |
| | | items?api-version=2015-09-01 |
| Request | | |
| Parameters | Argument | Description |
| | datasetName | Name of the dataset |
| | tableName | Name of the table |

| | |
|---|---|
| Request Body | { |

“bugTitle” : “Contoso app fails to load on
Windows 10”,
“assignedTo” : “john.doe@contoso.com”,

| | } | |
|---|---|---|
| | Status Code | |
| Response | HTTP Status | Scenario |
| | 201 | Item created |
| | 400 | Invalid request parameters/body |
| | 401 | Unauthorized request |
| | 404 | Non-existent dataset/table |
| | 409 | Item already exists |

| | |
|---|---|
| Response | { |

| | |
|---|---|
| Body | “bugId” : 12345, |
| | “bugTitle” : “Contoso app fails to load on |
| | Windows 10”, |
| | “assignedTo” : “john.doe@contoso.com”, |
| | “_etag” : “<opaque string>” |

}
wherein:
‘bugId’ is a read-only server-generated property.
Hence it is not present in the request body. The caller
gets the id in the response.

Get An Item—the following defines a REST API for fetching an item from a given table.

| Request | HTTP Method | Request URI |
|---|---|---|
| | GET | /datasets/{datasetName}/tables/ |
| | | {tableName}/items/{id}?api- |
| | | version=2015-09-01 |
| Request | | |
| Parameters | Argument | Description |
| | datasetName | Name of the dataset |
| | tableName | Name of the table |
| | Id | Primary key of the item |
| Headers | Header | Description |
| | If-none-match | [Optional] etag for the item |
| | Status Code | |
| Response | HTTP Status | Scenario |
| | 200 | Operation completed successfully |
| | 304 | Item not modified |
| | 400 | Invalid request parameters/body |
| | 401 | Unauthorized request |
| | 404 | Non-existent dataset/table |

| | |
|---|---|
| Response Body | { |

“bugId” : 12345,
“bugTitle” : “Contoso app fails to load on Windows
10”,
“assignedTo” : “john.doe@contoso.com”,
“_etag” : “<opaque string>”

}

List Items—The following defines the REST API for listing items from a given table.

| Request | HTTP Method | Request URI |
|---|---|---|
| | GET | /datasets/{datasetName}/tables/{tableName}/ |
| | | items?$filter=’CreatedBy’ eq |
| | | john.doe’&$top=50&$orderby=’Priority’ |
| | | asc, ’CreationDate’ desc |
| Request | | |
| Parameters | Argument | Description |
| | datasetName | Name of the dataset |
| | tableName | Name of the table |
| Filters | | Items can be filtered using $filter query |
| | | parameter. |
| Sorting | | Items can be sorted using $orderby query |
| | | parameter. Items get sorted by first field in |
| | | the query followed by second one and so |
| | | on. |
| Pagination | | $top query parameter is used to specify |
| | | desired page size. |
| | Status Code | |
| Response | HTTP Status | Scenario |
| | 200 | Operation completed successfully |
| | 400 | Invalid request parameters/body |
| | 401 | Unauthorized request |
| | 404 | Non-existent table |
| | 200 | Operation completed successfully |

| | |
|---|---|
| Response | { |

| | |
|---|---|
| Body | “value”: [ |

{

“bugId” : 12345,
“bugTitle” : “Contoso app fails to load on Windows 10”,
“assignedTo” : “john.doe@contoso.com”,
“_etag” : “<opaque string>”

},
...,

],
“nextLink” :

“{originalRequestUrl}?$skipToken={opaqueString}”
}

Patch An Item—the following defines a REST API for updating an item in a table.

| | HTTP | |
|---|---|---|
| Request | Method | Request URI |
| | PATCH | /datasets/{datasetName}/tables/ |
| | | {tableName}/items/{id} |
| Request | | |
| Parameters | Argument | Description |
| | datasetName | Name of the dataset |
| | tableName | Name of the table |
| | Id | Primary key of the item |
| Headers | Header | Description |
| | If-match | [Optional] Old etag for the item |

| | |
|---|---|
| Request Body | { |

“bugId” : “12345”,
“assignedTo” : bob@contoso.com”,

| | } | |
|---|---|---|
| | Status Code | |
| Response | HTTP Status | Scenario |
| | 200 | Operation completed successfully |
| | 400 | Invalid request parameters/body |
| | 401 | Unauthorized request |
| | 404 | Non-existent dataset/table |
| | 412 | Version/etag mismatch |
| | Precondition | |
| | Failed | |

| | |
|---|---|
| Response | { |

| | |
|---|---|
| Body | “bugId” : 12345, |
| | “bugTitle” : “Contoso app fails to load on |
| | Windows 10”, |
| | “assignedTo” : “bob@contoso.com”, |
| | “_etag” : “<opaque string>” |

}

Delete An Item—the following defines a REST API for deleting an item in a table.

| | HTTP | |
|---|---|---|
| Request | Method | Request URI |
| | DELETE | /datasets/{datasetName}/tables/{tableName}/ |
| | | items/{id} |
| Request | | |
| Parameters | Argument | Description |
| | datasetName | Name of the dataset |
| | tableName | Name of the table |
| | Id | Primary key of the item |
| Headers | Header | Description |
| | If-match | [Optional] Old etag for the item |
| | Status Code | |
| Response | HTTP Status | Scenario |
| | 200 | Operation completed successfully |
| | 400 | Invalid request parameters/body |
| | 401 | Unauthorized request |
| | 404 | Non-existent dataset/table |
| | 412 | Version/etag mismatch |
| | Precondition | |
| | Failed | |

Table Data Triggers. A REST API trigger is a mechanism that fires an event so that clients of the API can take appropriate action in response to the event. Triggers may take the form of poll trigger, in which a client polls the API for notification of an event having been fired, and push triggers, in which the client is notified by the API when an event fires. For example, in a tabular data contract, the API notifies the client application when a particular event occurs, such as addition of a new item in a table or updates to an item, so that the application can take action as appropriate.

New Item—the following defines a REST API for a new item trigger.

| | HTTP | |
|---|---|---|
| Request | Method | Request URI |
| | GET | /datasets/{datasetName}/tables/{tableName}/ |
| | | newitem? $filter=’CreatedBy’ eq |
| | | john.doe’&triggerState= {state}&api- |
| | | version=2015-09-01 |
| Request | | |
| Parameters | Argument | Description |
| | datasetName | Name of the dataset |
| | tableName | Name of the table |
| | filter | OData filter query |
| | triggerState | Trigger state |
| | Status Code | |
| Response | HTTP Status | Scenario |
| | 200 | Operation completed successfully |
| | 202 | No change |
| | 400 | Invalid request parameters/body |
| | 401 | Unauthorized request |
| | 404 | Non-existent dataset/table |

| | |
|---|---|
| Response | { |

| | |
|---|---|
| Body | “bugId” : 12345, |
| | “bugTitle” : “Contoso app fails to load on Windows |
| | 10”, |
| | “assignedTo” : “john.doe@contoso.com”, |
| | “_etag” : “<opaque string>” |

}

Updated Item—the following defines a REST API for an updated item trigger.

| | HTTP | |
|---|---|---|
| Request | Method | Request URI |
| | GET | /datasets/{datasetName}/tables/ |
| | | {tableName}/ updateditem? |
| | | $filter=’CreatedBy’ eq |
| | | ’john.doe’&triggerState={state}&api- |
| | | version=2015-09-01 |
| Request | | |
| Parameters | Argument | Description |
| | datasetName | Name of the dataset |
| | tableName | Name of the table |
| | filter | OData filter query |
| | triggerState | Trigger state |
| | Status Code | |
| Response | HTTP Status | Scenario |
| | 200 | Operation completed successfully |
| | 202 | No change |
| | 400 | Invalid request parameters/body |
| | 401 | Unauthorized request |
| | 404 | Non-existent dataset/table |

| | |
|---|---|
| Response | { |

| | |
|---|---|
| Body | “bugId” : 12345, |
| | “bugTitle” : “Contoso app fails to load on Windows |
| | 10”, |
| | “assignedTo” : “john.doe@contoso.com”, |
| | “_etag” : “<opaque string>” |

}

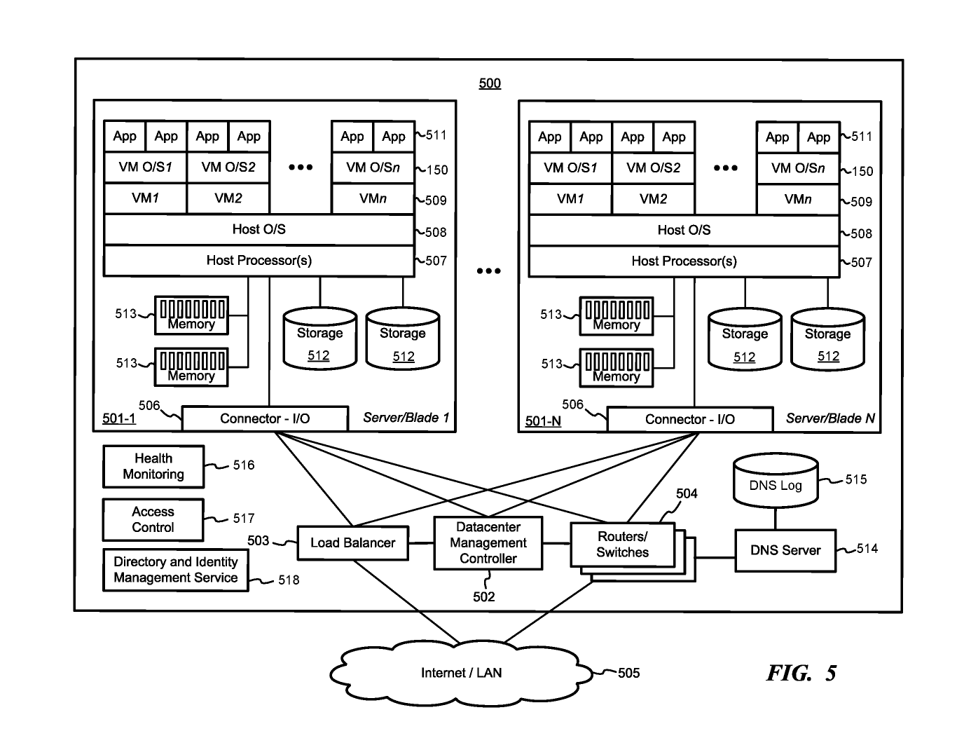

FIG. 4 illustrates the resource hierarchy for blob data, which is organized as a series of folders or containers. A container 401 contains sub-containers 402 and blobs 402. The sub-containers 402 can recursively contain containers 404 and blobs 405. A container corresponds to a folder in file system. A blob is a leaf node that represents a binary object. A blob corresponds to a file within a folder in file system.

File Data Service—this service exposes runtime APIs for CRUD operations on files.

Create A File—the following defines a REST API for creating a file.

| | HTTP | |
|---|---|---|
| Request | Method | Request URI |
| | POST | /api/blob/files{path}?folderPath={path}& |
| | | name= {name} |
| Request | | |
| Parameters | Argument | Description |
| | path | Relative path of the folder from the root |
| | | container where file needs to be created. |
| | name | File name |
| Request Body | | The file content to be uploaded goes in the |
| | | request body. |
| | Status Code | |
| Response | HTTP Status | Scenario |
| | 200 | Operation completed successfully |
| | 400 | Invalid request parameters/body |
| | 401 | Unauthorized request |

| | |
|---|---|
| Response | { |

| | |
|---|---|
| Body | “Id” : “images%252Fimage01.jpg”, |
| | “Name” : “image01.jpg”, |
| | “DisplayName” : “image01.jpg”, |
| | “Path” : “images/image01.jpg”, |

“Size” : 1024,
“LastModified” : “06/11/2015 12:00:00 PM”,
“IsFolder” : false
“ETag” : “<opaque string>”

| | } | |
|---|---|---|
| | The response body contains the blob metadata | |
| Response | | |
| Headers | Header | Description |
| | etag | Entity tag for the blob |

Update A File—the following defines a REST API for updating a file.

| | HTTP | |
|---|---|---|
| Request | Method | Request URI |
| | PUT | /api/blob/files/{id} |
| Request | | |
| Parameters | Argument | Description |
| | id | Unique identifier of the file |
| Headers | Header | Description |
| | If-match | [Optional] Old etag for the blob. |
| Request Body | | The blob content to be uploaded goes in |
| | | the request body. |
| | Status Code | |
| Response | HTTP Status | Scenario |
| | 200 | Operation completed successfully |
| | 400 | Invalid request parameters/body |
| | 401 | Unauthorized request |
| | 412 | Version/etag mismatch |
| | Precondition | |
| | Failed | |
| | 404 | File not found |

| | |
|---|---|
| Response | { |

| | |
|---|---|
| Body | “Id” : “images%252Fimage01.jpg”, |
| | “Name” : “image01.jpg”, |
| | “DisplayName” : “image01.jpg”, |
| | “Path” : “images/image01.jpg”, |

“Size” : 1024,
“LastModified” : “06/11/2015 12:00:00
PM”,
“IsFolder” : false
“ETag” : “<opaque string>”

| | } | |
|---|---|---|
| | The response body contains the blob metadata | |
| Response | | |
| Headers | Header | Description |
| | etag | Entity tag for the blob |

Get A File Metadata—the following defines a REST API for getting file metadata using a file identifier.

| | HTTP | |
|---|---|---|
| Request | Method | Request URI |
| | GET | /api/blob/files/{id} |
| Request | | |
| Parameters | Argument | Description |
| | id | Unique identifier of the file |
| Headers | Header | Description |
| | If-none-match | [Optional] etag for the blob |
| | Status Code | |
| Response | HTTP Status | Scenario |
| | 200 | Operation completed successfully |
| | 304 | File not modified |
| | 400 | Invalid request parameters/body |
| | 401 | Unauthorized request |
| | 404 | File not found |
| Response | | |
| Headers | Header | Description |
| | etag | Entity tag for the blob |

| | |
|---|---|
| Response | { |

| | |
|---|---|
| Body | “Id” : “images%252Fimage01.jpg”, |
| | “Name” : “image01.jpg”, |
| | “DisplayName” : “image01.jpg”, |
| | “Path” : “images/image01.jpg”, |

“Size” : 1024,
“LastModified” : “06/11/2015 12:00:00 PM”,
“IsFolder” : false
“ETag” : “<opaque string>”

}
The response body contains the blob metadata

Get A File Metadata By Path—the following defines a REST API for getting file metadata using the path to the file.

| | HTTP | |
|---|---|---|
| Request | Method | Request URI |
| | GET | /api/blob/files/{path} |
| Request | | |
| Parameters | Argument | Description |
| | path | Url encoded relative path of the file from |
| | | the root of the connection. |
| Headers | Header | Description |
| | If-none-match | [Optional] etag for the blob |
| | Status Code | |
| Response | HTTP Status | Scenario |
| | 200 | Operation completed successfully |
| | 304 | File not modified |
| | 400 | Invalid request parameters/body |
| | 401 | Unauthorized request |
| | 404 | File not found |
| Response | | |
| Headers | Header | Description |
| | etag | Entity tag for the blob |
| Response | The response | { |

| | | |
|---|---|---|
| Body | body contains | “Id” : “images%252Fimage01.jpg”, |
| | the blob | “Name” : “image01.jpg”, |
| | metadata | “DisplayName” : “image01.jpg”, |
| | | “Path” : “images/image01.jpg”, |

“Size” : 1024,
“LastModified” : “06/11/2015

12:00:00 PM”,

“IsFolder” : false
“ETag” : “<opaque string>”

}

Get A File Content—the following defines a REST API for getting the content of a file.

| | HTTP | |
|---|---|---|
| Request | Method | Request URI |
| | GET | /api/blob/files/{id}/content |
| Request | | |
| Parameters | Argument | Description |
| | id | Unique identifier of the file |
| Headers | Header | Description |
| | If-none-match | [Optional] etag for the blob |
| | Status Code | |
| Response | HTTP Status | Scenario |
| | 200 | Operation completed successfully |
| | 304 | File not modified |
| | 400 | Invalid request parameters/body |
| | 401 | Unauthorized request |
| | 404 | File not found |
| Response | | |
| Headers | Header | Description |
| | etag | Entity tag for the blob |
| Response | | The response body contains the blob |
| Body | | content. |

Delete A File—the following defines a REST API for deleting a file.

| | HTTP | |
|---|---|---|
| Request | Method | Request URI |
| | DELETE | /api/blob/files/{id} |
| Request | | |
| Parameters | Argument | Description |
| | id | Unique identifier of the file |
| Headers | Header | Description |
| | If-none-match | [Optional] etag for the blob |
| | Status Code | |
| Response | HTTP Status | Scenario |
| | 200 | Operation completed successfully |
| | 400 | Invalid request parameters/body |
| | 401 | Unauthorized request |
| | 412 | Version/etag mismatch |
| | Precondition | |
| | Failed | |

Folder data Service—this service exposes runtime APIs for CRUD operations on folders.

List A Folder—the following defines the REST API for enumeration of files and folders. The API returns a list of files and folders under the current folder. This API enumerates the top level files and folders present in the current folder, but does not recursively enumerate files and folders inside sub-folders.

| | HTTP | |
|---|---|---|
| Request | Method | Request URI |
| | GET | /api/blob/folders/{id} |
| Request | | |
| Parameters | Argument | Description |
| | id | Unique identifier of the file |
| | Status Code | |
| Response | HTTP Status | Scenario |
| | 200 | Operation completed successfully |
| | 400 | Invalid request parameters/body |
| | 401 | Unauthorized request |
| | 404 | Folder not found |

| | |
|---|---|
| Response | { |

| | |
|---|---|
| Body | “value” : [ |

{

“Id” : “images%252Fimage01.jpg”,
“Name” : “image001.jpg”,
“DisplayName” : “image001.jpg”
“Path” : “/images/ image001.jpg”
“LastModifed” : “7/21/2015 12:15 PM”,
“Size” : 1024,
“IsFolder” : false

},
...

],
“odata.nextLink” :

“{originalRequestUrl}?$skip={opaqueString}”
}
When all items cannot fit in a single page, the response
contain link to the next page url in the response body.

Archive Service

Copy File—the following defines a REST API for copying a file from a publicly accessible data source.

| | HTTP | |
|---|---|---|
| Request | Method | Request URI |
| | GET | /api/blob/copyFile?source={source |
| | | uri}&destination={destination |
| | | uri}&overwrite={true\|false}&api- |
| | | version=2015-09-01 |
| Request | | |
| Parameters | Argument | Description |
| | source | Source uri of the file |
| | destination | Destination uri for the file |
| | overwrite | Overwrite existing file if true |
| | Status Code | |
| Response | HTTP Status | Scenario |
| | 200 | Operation completed successfully |
| | 400 | Invalid request parameters/body |
| | 401 | Unauthorized request |
| | 404 | File not found |

Extract Folder—the following defines a REST API for extracting a folder from a zipped file.

| | HTTP | |
|---|---|---|
| Request | Method | Request URI |
| | GET | /api/blob/extractFolder?source={source |
| | | uri}&destination={destination |
| | | uri}&overwrite={true\|false}&api- |
| | | version=2015-09-01 |
| Request | | |
| Parameters | Argument | Description |
| | source | Source uri of the file |
| | destination | Destination uri for the file |
| | overwrite | Overwrite existing file(s) if true |
| | Status Code | |
| Response | HTTP Status | Scenario |
| | 200 | Operation completed successfully |
| | 400 | Invalid request parameters/body |
| | 401 | Unauthorized request |
| | 404 | File not found |

File Triggers—like the Table Data Triggers disclosed above, REST API triggers can fire on file-related events so that clients of the API can take appropriate action in response to the event.

New File—the following defines a REST API for a new file trigger.

| | HTTP | |
|---|---|---|
| Request | Method | Request URI |
| | GET | /api/trigger/file/new?folderId={folder |
| | | id} |
| Request | | |
| Parameters | Argument | Description |
| | folder id | Unique identifier of the folder |
| | Status Code | |
| Response | HTTP Status | Scenario |
| | 200 | Operation completed successfully |
| | 202 | No change |
| | 400 | Invalid request parameters/body |
| | 401 | Unauthorized request |
| | 404 | Folder not found |

| | |
|---|---|
| Response | { |

| | |
|---|---|
| Body | “Id” : “images%252Fimage01.jpg”, |
| | “Name” : “image01.jpg”, |
| | “DisplayName” : “image01.jpg”, |
| | “Path” : “images/image01.jpg”, |

“Size” : 1024,
“LastModified” : “06/11/2015 12:00:00 PM”,
“IsFolder” : false
“ETag” : “<opaque string>”

}

Other file triggers, such as update file triggers, may also be provided by REST APIs.

Composite Connectors—in certain scenarios, a file may be represented both as a blob in a file system and as a dataset. For example a spreadsheet file, such as an Excel file, exists as a blob in a file system, but the file is also a dataset because it has tables inside of it. A composite connector relies upon both tabular data and blob data contracts. A client application first has to navigate to a folder storing the individual file, and then must choose inside the file what table and what columns and rows should be operated on. Composite connectors allow the client application to access the file on any storage service and then access the tables and items within the file itself.

In an example embodiment, an Excel connector is a composite connector that depends on blob-based connectors for storage of the blob or file. Following table summarizes the requirements on the blob-based connectors to support such composite connectors:

| Requirement | Purpose |
|---|---|
| Versioning | Needed for detecting changes in |
| | the blob |
| Conditional | Needed for server-side caching. |
| read | Server refreshes cache only if it |
| | has changed. Caching makes reads |
| | exceptionally fast for excel. |
| Conditional | Needed to avoid blob over-write |
| write | |

Following table captures features of some of example blob-based SaaS services. Corresponding connectors leverage these features or are limited by absence of them.

| Service | Versioning | Conditional read | Conditional write |
|---|---|---|---|
| DropBox | Yes | Yes | Yes |
| | (etag) | (If-none-match | (If-match header) |
| | | header) | |
| OneDrive | Yes | Yes | No |
| | (Updated time) | (Use updated time | (Potential for over- |
| | | present in blob | write) |
| | | metadata) | |
| SharePoint | Yes | Yes | No |
| | (Updated time) | (Use updated time | (Potential for over- |
| | | present in blob | write) |
| | | metadata) | |

An example system for connecting applications to services comprises a processor and memory configured to provide a connector that uses a common contract to expose a data source to an application, the common contract providing access to a plurality of different dataset types without requiring the application to know the specific dataset type used by the data source.

In alternative embodiments, the connector exposes an API for managing datasets according to the common contract.

In alternative embodiments, the common contract provides a standardized interface to perform Create, Read, Update, Delete (CRUD) operations on the data sources using APIs.

In alternative embodiments, the data source comprises a tabular data resource hierarchy.

In alternative embodiments, the application calls the API to manage tables and items in the data set using the common contract.

In alternative embodiments, the data source comprises a blob data resource hierarchy.

In alternative embodiments, the application calls the API to manage folders and files.

In alternative embodiments, the connector exposes an API for triggering actions when a dataset event is detected.

In alternative embodiments, the connector is a composite connector that exposes APIs for managing data resources using both a tabular data hierarchy and a blob data hierarchy according to the common contract.

In alternative embodiments, the system further comprises a distributed computer network hosting a plurality of connectors, wherein each of the connectors is associated with a different data source and exposes an API for managing data on each data source according to the common contract.

An example computer-implemented method for connecting applications to services comprises providing a connector that uses a common contract to expose a data source to an application, and providing access to a plurality of different dataset types using the common contract without requiring the application to know the specific dataset type used by the data source.

In other embodiments of the method, the connector exposes an API for managing datasets according to the common contract.

In other embodiments of the method, the common contract provides a standardized interface to perform Create, Read, Update, Delete (CRUD) operations on the data sources using APIs.

In other embodiments of the method, the data source comprises a tabular data resource hierarchy.

In other embodiments, the method further comprises receiving API calls from the application at the connector to manage tables and items in the data set using the common contract.

In other embodiments of the method, the data source comprises a blob data resource hierarchy.

In other embodiments, the method further comprises receiving API calls from the application at the connector to manage folders and files.

In other embodiments, the method further comprises exposing an API by the connector for triggering actions when a dataset event is detected.

In other embodiments of the method, the connector is a composite connector that exposes APIs for managing data resources using both a tabular data hierarchy and a blob data hierarchy according to the common contract.

In other embodiments, the method further comprises associating a plurality of connectors in a distributed computer network with a different data source, and exposing an API for managing data on each data source according to the common contract.

FIG. 5 is a high level block diagram of an example datacenter 500 that provides cloud computing services or distributed computing services using connectors as disclosed herein. These services may include connector services as disclosed in FIGS. 1 and 2. A plurality of servers 501 are managed by datacenter management controller 502. Load balancer 503 distributes requests and workloads over servers 501 to avoid a situation wherein a single server may become overwhelmed. Load balancer 503 maximizes available capacity and performance of the resources in datacenter 500. Routers/switches 504 support data traffic between servers 501 and between datacenter 500 and external resources and users (not shown) via an external network 505, which may be, for example, a local area network (LAN) or the Internet.

Servers 501 may be standalone computing devices and/or they may be configured as individual blades in a rack of one or more server devices. Servers 501 have an input/output (I/O) connector 506 that manages communication with other database entities. One or more host processors 507 on each server 501 run a host operating system (O/S) 508 that supports multiple virtual machines (VM) 509. Each VM 509 may run its own O/S so that each VM O/S 150 on a server is different, or the same, or a mix of both. The VM O/S's 150 may be, for example, different versions of the same O/S (e.g., different VMs running different current and legacy versions of the Windows® operating system). In addition, or alternatively, the VM O/S's 150 may be provided by different manufacturers (e.g., some VMs running the Windows® operating system, while others VMs are running the Linux® operating system). Each VM 509 may also run one or more applications (App) 511. Each server 501 also includes storage 512 (e.g., hard disk drives (HDD)) and memory 513 (e.g., RAM) that can be accessed and used by the host processors 507 and VMs 509 for storing software code, data, etc. In one embodiment, a VM 509 may host client applications, data sources, data services, and/or connectors as disclosed herein.

Datacenter 500 provides pooled resources on which customers or tenants can dynamically provision and scale applications as needed without having to add servers or additional networking. This allows tenants to obtain the computing resources they need without having to procure, provision, and manage infrastructure on a per-application, ad-hoc basis. A cloud computing datacenter 500 allows tenants to scale up or scale down resources dynamically to meet the current needs of their business. Additionally, a datacenter operator can provide usage-based services to tenants so that they pay for only the resources they use, when they need to use them. For example, a tenant may initially use one VM 509 on server 501-1 to run their applications 511. When demand for an application 511 increases, the datacenter 500 may activate additional VMs 509 on the same server 501-1 and/or on a new server 5-N as needed. These additional VMs 509 can be deactivated if demand for the application later drops.

Datacenter 500 may offer guaranteed availability, disaster recovery, and back-up services. For example, the datacenter may designate one VM 509 on server 501-1 as the primary location for the tenant's application and may activate a second VM 509 on the same or different server as a standby or back-up in case the first VM or server 501-1 fails. Database manager 502 automatically shifts incoming user requests from the primary VM to the back-up VM without requiring tenant intervention. Although datacenter 500 is illustrated as a single location, it will be understood that servers 501 may be distributed to multiple locations across the globe to provide additional redundancy and disaster recovery capabilities. Additionally, datacenter 500 may be an on-premises, private system that provides services to a single enterprise user or may be a publically accessible, distributed system that provides services to multiple, unrelated customers and tenants or may be a combination of both.

Domain Name System (DNS) server 514 resolves domain and host names into IP addresses for all roles, applications, and services in datacenter 500. DNS log 515 maintains a record of which domain names have been resolved by role. It will be understood that DNS is used herein as an example and that other name resolution services and domain name logging services may be used to identify dependencies. For example, in other embodiments, IP or packet sniffing, code instrumentation, or code tracing.

Datacenter health monitoring 516 monitors the health of the physical systems, software, and environment in datacenter 500. Health monitoring 516 provides feedback to datacenter managers when problems are detected with servers, blades, processors, or applications in datacenter 500 or when network bandwidth or communications issues arise.

Access control service 517 determines whether users are allowed to access particular connections and services on cloud service 500. Directory and identify management service 518 authenticates user credentials for tenants on cloud service 500.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for connecting applications to services, the system comprising: a processor and memory configured to:
provide a connector that uses a common contract to expose a data source to an application, the common contract providing access to a plurality of different dataset types without requiring the application to know the specific dataset type used by the data source.

2. The system of claim 1, wherein the connector exposes an application program interface (API) for managing datasets according to the common contract.

3. The system of claim 2, wherein the common contract provides a standardized interface to perform Create, Read, Update, Delete (CRUD) operations on the data sources using APIs.

4. The system of claim 2, wherein the data source comprises a tabular data resource hierarchy.

5. The system of claim 4, wherein the application calls the API to manage tables and items in the data set using the common contract.

6. The system of claim 2, wherein the data source comprises a blob data resource hierarchy.

7. The system of claim 6, wherein the application calls the API to manage folders and files.

8. The system of claim 1, wherein the connector exposes an application program interface (API) for triggering actions when a dataset event is detected.

9. The system of claim 1, wherein the connector is a composite connector that exposes application program interfaces (API) for managing data resources using both a tabular data hierarchy and a blob data hierarchy according to the common contract.

10. The system of claim 1, further comprising:
a distributed computer network hosting a plurality of connectors, wherein each of the connectors is associated with a different data source and exposes an application program interface (API) for managing data on each data source according to the common contract.

11. A computer-implemented method for connecting applications to services, comprising:
providing a connector that uses a common contract to expose a data source to an application; and
providing access to a plurality of different dataset types using the common contract without requiring the application to know the specific dataset type used by the data source.

12. The method of claim 11, wherein the connector exposes an application program interface (API) for managing datasets according to the common contract.

13. The method of claim 12, wherein the common contract provides a standardized interface to perform Create, Read, Update, Delete (CRUD) operations on the data sources using APIs.

14. The method of claim 12, wherein the data source comprises a tabular data resource hierarchy.

15. The method of claim 14, further comprising:
receiving API calls from the application at the connector to manage tables and items in the data set using the common contract.

16. The method of claim 12, wherein the data source comprises a blob data resource hierarchy.

17. The method of claim 16, further comprising:
receiving API calls from the application at the connector to manage folders and files.

18. The method of claim 1, further comprising:
exposing an application program interface (API) by the connector for triggering actions when a dataset event is detected.

19. The method of claim 1, wherein the connector is a composite connector that exposes application program interfaces (API) for managing data resources using both a tabular data hierarchy and a blob data hierarchy according to the common contract.

20. The method of claim 1, further comprising:
associating a plurality of connectors in a distributed computer network with a different data source; and
exposing an application program interface (API) for managing data on each data source according to the common contract.
